(19) United States
(12) Patent Application Publication
(10) Pub. No.: US 2006/0030339 A1
(43) Pub. Date: Feb. 9, 2006

(54) Implementation of serverless applications over wireless networks

(76) Inventors: Igor Zhovnirovsky, Newton, MA (US); Pavel Bochman, Plainview, NY (US)

Correspondence Address: GOODWIN PROCTER LLP;PATENT ADMINISTRATOR, EXCHANGE PLACE, BOSTON, MA, 02109-2881, US

(21) Appl. No.: 11/196,600

(22) Filed: Aug. 3, 2005

Related U.S. Application Data
(60) Provisional application No. 60/598,805, filed on Aug. 4, 2004.

(51) Int. Cl. H04Q 7/20

(52) U.S. Cl. 455/456.6; 455/456.1

(57) ABSTRACT

The location of a wireless handset is determined from a station such as another wireless handset in order, for example, to keep track of the current location of a child, friend or asset.

### RELATED APPLICATION

This application claims priority to and the benefits of U.S. provisional application Ser. No. 60/598,805, filed on Aug. 4, 2004 and entitled “System for Implementing Serverless Applications Over the Public Wireless Network,” the entire disclosure of which is hereby incorporated by reference.

### FIELD OF THE INVENTION

The present invention relates to wireless communication and, in particular, to location-related applications implemented on wireless handsets.

### BACKGROUND OF THE INVENTION

Cellular telephones are essentially very small computers. The public wireless cellular-network system has evolved into a powerful platform that supports computer applications well beyond voice communications. The wireless network system is based on a stationary, wired communication network and numerous roaming wireless handsets capable of communicating via this network. The stationary network provides support for high-capacity data traffic and is connected to the Internet.

Today's handsets support data services in addition to voice calls. Modern handsets have fast central processing units (CPUs), large color screens, large memory capacities, permanent data storage, local wireless connectivity, cameras, movie recorders and other enhancements that take them from the class of communication devices into the class of computing devices.

Indeed, the cell phone has rapidly become the personal communications device of choice around the world. With the availability of “all-in-one” chipsets (incorporating IrDA, Bluetooth, Wi-Fi, GPS and faster processors), along with the evolution of networks with larger bandwidth and the viability of multi-modality operation, this trend will accelerate as carriers deploy an ever-widening range of applications. The development of handset-based applications is driven both by the expanding capabilities of even inexpensive handsets and the need to create differentiation in an increasingly commoditized wireless market.

One class of application of interest to a broad range of wireless customers is location-based services (LBS)—programs that enable a cell phone user to easily locate and communicate with friends, family members, employees, mobile assets, etc. directly from the handset. LBS enables many consumer and commercial applications and promises to drive demand, thereby creating differentiation in the marketplace for the wireless carrier that offers it.

To appeal to a consumer market, LBS services should be intuitively user-friendly, inexpensive and safe to use. Current LBS solutions, however, employ a client-server architecture, which poses disadvantages for both the consumer/user and the carrier/developer.

For consumers, a client-server approach is problematic, first, because it is vulnerable: hackers can break into a central server and access private location information. Even with perfect security, the perception of a central repository of location information can generate privacy-related concerns that lessen consumer appeal. Client-server implementations also tend to be complex and, as a result, costly. Consumers will reject high monthly fees merely, for example, in order to locate their children or to find friends, nor will they welcome the need to configure browsers or install servers just to run an LBS application. Yet many client-server solutions require, at the least, a PC/browser with internet connectivity to implement, and some can be managed and operated only from the desktop, tying down the user. Finally, some existing LBS applications are “native carrier only,” meaning that users can only locate other users running on the same cellular network.

Client-server architectures have disadvantages for the wireless carriers as well. The most significant of these, once again, stem from complexity translating into cost: expensive back-end infrastructure build-outs are ordinarily required to run the application, account for usage and bill the user; either the carrier or its partner developer must invest in the infrastructure necessary to roll out, maintain and scale the application. Indeed, scaling can itself represent a considerable problem. When the number of users ramps up rapidly, more hardware is needed, imposing not only expense but delay as the new hardware is assimilated into the carrier's network. The new equipment tends to require significant professional services efforts (e.g., load balancing, redundancy, maintenance, and scaling schemes). Carriers must also contend with the cost of provisioning, i.e., entering new users into the server's database, and creating and managing profiles, histories, permissions and restrictions. Finally, the use of servers generally limits reliability and availability. The more servers that are needed, the higher are the chances that one of them will go down at any given moment. To compensate for that possibility even more servers are required, which themselves need to be organized in expensive cluster groups, further increasing costs.

### DESCRIPTION OF THE INVENTION

### Brief Summary of the Invention

The present invention provides a serverless approach to determining the location of a wireless phone from another wireless phone in order, for example, to keep track of the current location of a child, friend or asset. The invention can also be used to determine the current location of the user himself. In some embodiments, a software module is loaded into each phone, and this module, in response to the user's locate command on the querying (e.g., a parent's) phone, sends a message (e.g., a “Short Message Service,” or SMS, message) to the tracked phone requesting a location. In response, the tracked phone determines its location using, for example, the wireless carrier's location-determining technology, preferably encrypts the geographic coordinates, and sends these back to the querying phone (e.g., via another SMS message). It should be stressed that other transport mechanisms can be used to convey the request/response between phones, such as an Instant Messenger (IM) or other type of communication infrastructure or protocol. Important to the present invention is the fact that the transport system is generic and deployed by outside providers, rather than dedicated to the invention itself. It should also be noted that in some embodiments, communication occurs between a tracked phone and a PC, laptop, handheld device or other computational resource rather than between two phones, or directly between computational resources (with no phone involved).

In some embodiments, in order to display the coordinates as an address or visual location, the querying phone sends the coordinates to a geographic information server (GIS), which returns the street address and/or a map that the querying phone displays. Alternatively, the querying phone can store the names of various geographically specified locations (e.g., school, a friend's house, etc.) and, depending on the proximity of the tracked phone to one of these locations, report the location name. (Of course, the tracked phone may instead simply send geographic coordinates, and the querying phone may be configured to determine, based on the received coordinates, whether they are sufficiently proximate to a named location stored on the querying phone to justify displaying the named location.) Similarly, the tracked phone can be programmed to transmit an alert when it enters or leaves the proximity of a designated location.

In still other embodiments, the querying phone directly implements the functions associated with a GIS, i.e., storing mapping or other geographical information in Flash memory or the like, thereby eliminating the need for GIS queries.

The location information obtained by the querying phone can be used for applications beyond simple tracking. For example, the ability to track the location of a wireless handset can be used to facilitate location-aware marketing, emergency management, concierge networks, loss prevention (where determining the location of a handset suggests the location of an associated asset, such as a vehicle), logistics management, and team management. A tracking system can alert the querying phone to the proximity (e.g., within a distance set by the user) of other phones in a list. In these and other applications, the querying phone may not send actual queries; rather, the tracked phone(s) may be configured to push location data to the tracking phone on an event-based or periodic basis.

The peer-to-peer approach of the present invention offers numerous advantages, particularly when compared with traditional client-server methodologies. A tracked handset typically is not actually located other than in response to a request (which may be ongoing), and to ensure privacy and security, the tracked handset can be configured so that only requests from trusted querying hansets are processed. By avoiding the use of external resources in preparing and processing requests, the present invention is highly scalable and does not require additional network provisioning or hardware, with attendant load-balancing, redundancy, and maintenance concerns. Similarly, there is no need for central account registration or restriction of the service to particular accounts (since the location request can be sent to any handset, which may or may not respond, depending on the requester's privileges) or for provisioning (since set-up may be performed entirely by the user).

As used herein, the term “peer-to-peer” refers to a mode of communication in which no hierarchical relationship exists between communicating nodes or stations (e.g., cell phones or PCs), i.e., both stations have the same rights and privileges. The two stations need not be identical in capability (for example, a PC may communicate with a cell phone), but they have equivalent network roles—unlike a client-server system, for example, in which subordinate clients send requests to supervisory servers, which process and service those requests. In a similar vein, the term “serverless” refers to an application architecture in which communicating nodes or stations peform the functions associated with an application, such as LBS, without resort to external resources such as application servers or the like. This does not mean, it should be emphasized, that servers are uninvolved entirely. The present invention typically involves communication via the public wireless network, which contains many servers, and in some cases the Internet. An external server such as a GIS, for example, may be employed as a resource. But an application is nonetheless “serverless” so long as its basic functionality—other than communication—does not require external server support.

Accordingly, in a first aspect, the invention comprises a method of performing location-based services involving first and second wireless stations in communication via a public wireless network. At least the second station is a handset including functionality for determining its location. Without use of an external resource, a peer-to-peer location request for the second station is prepared on the first station. The location request is transmitted from the first station to the second station via the public wireless network, and is received at the second station. In response, the second station determines its location, and without use of an external resource, prepares a peer-to-peer response including the determined location. The response is transmitted from the second station to the first station via the public wireless network.

The location-determining step may, in some embodiments, include wireless communication between the second station and an external server, while in other embodiments the location-determining step is accomplished without use of an external resource. The method may involve encrypting the request prior to transmission thereof, and may be accomplished on the first station without use of an external resource. Similarly, the method may involve encrypting the response prior to transmission thereof, and once again, encryption may be accomplished on the second station without use of an external resource.

In some embodiments he request and response are transmitted using SMS, while in other embodiments IM is employed, but the message protocol is not critical to the invention.

The obtained location may be displayed geographically (e.g., in the form of a map) on the first station, or may instead (or in addition) be displayed using a name corresponding to the location. The name may be determined based on a determined geographic location and its proximity to a named location.

The tracked (second) station may determine its location in response to the request or may instead determine its location periodically, returning the most recently determined location in response to a request.

Another aspect of the invention involves “push” or alert-based location messages. Accordingly, a method of performing location-based services involving this aspect of the invention once again utilizes first and second wireless stations in communication via a public wireless network; at least the second station is a handset including functionality for determining its location. The second station periodically determines its location, and upon occurrence of an event and without use of an external resource, the second station prepares a peer-to-peer message based on the determined (or most recently determined) location. The second station thereupon causes transmission of the message to the first station via the public wireless network.

In some embodiments, the message is encrypted prior to transmission thereof, and encryption is accomplished on the second station without use of an external resource. SMS, IM or any other suitable message protocol may be used. The event may be a location request from the first station, entry of the second station into proximity to a predetermined location, elapse of a predetermined time, or other designated occurrence.

In another aspect, the invention comprises a wireless telephone handset. The handset includes telephony circuitry for receiving and transmitting voice and data via a public wireless network; a user interface facilitating selection of a command to request a remote station's location; a module, responsive to the command, for preparing, without use of an external resource, a location request for the remote station and for causing transmission of the location request to the remote station via the public wireless network; and a module for interpreting a response (which includes the determined location) received from the remote station, and displaying the location on the user interface.

In some embodiments, the handset is configured to serve as a querying as well as a tracked device, and includes functionality for determining its location as well as a module, responsive to location requests transmitted by another handset, for preparing responses (which include the determined location) to the location requests, and causing transmission of the location requests to the other handset via the public wireless network.

In some embodiments, the location-determining functionality effectuates communication between the handset and an external server in determining the location, while in other embodiments, the location-determining functionality determines the location without use of an external resource. The handset may also include encryption/decryption capability as described above.

A response may characterize the handset's location geographically or by using a name therefor, e.g., based on a determined geographic location and its proximity to a named location.

In some embodiments, the handset comprises memory circuitry for storing digital images each associated with data facilitating communication with a remote station. The user interface facilitates display of and selection among the digital images. Selection of an image causes preparation and transmission of the location request to the remote station associated with the image. The handset may, for example, include a camera for recording the digital images. The user interface facilitates association between a recorded image and data facilitating communication with a remote station.

The handset may determine its location in response to location requests transmitted by another handset, or may determine its location periodically, in which cases a response to a location request is based on a most recently determined location.

In another aspect, a wireless telephone handset in accordance with the invention comprises telephony circuitry for receiving and transmitting voice and data via a public wireless network, functionality for periodically determining the location of the handset, and a module for preparing messages based on the determined location. In response to occurrence of an event, the module and the telephony circuitry cause the message to be transmitted another handset via the public wireless network. Once again the event may be a location request from another station, entry into proximity to a predetermined location, elapse of a predetermined time, or other designated occurrence.

### BRIEF DESCRIPTION OF THE DRAWINGS

The foregoing discussion will be understood more readily from the following detailed description of the invention, when taken in conjunction with the accompanying drawings, in which:

FIG. 1 schematically illustrates the overall peer-to-peer approach of the invention;

FIG. 2 is a block diagram of a handset implementing both query and response functionality;

FIG. 3 schematically illustrates a representative code architecture implementing the functionality shown in FIG. 2;

FIG. 4 shows the location message sequence that takes place when one station (“Phone1”) requests a location from a second station (“Phone2”);

FIG. 5 illustrates processing of a location request;

FIG. 6 illustrates processing of a response to a location request;

FIG. 7 illustrates encryption of an outgoing peer-to-peer message;

FIG. 8 illustrates decryption of an incoming peer-to-peer message;

FIG. 9 illustrates an approach to generation of an initial encryption key; and

FIG. 10 illustrates how subsequent encryption keys may be generated after the initial encryption key is used.

### DETAILED DESCRIPTION OF THE PREFERRED EMBODIMENTS

Basic Architecture and Functionality

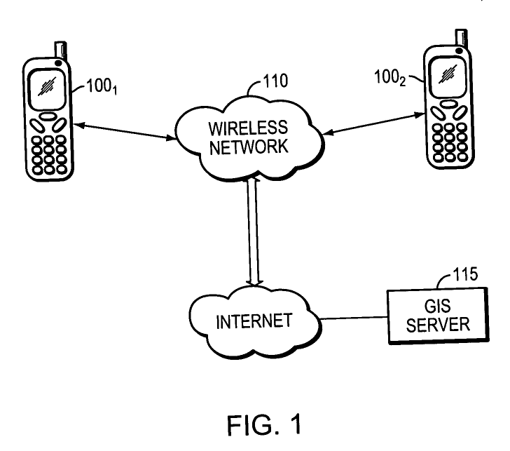

FIG. 1 illustrates the peer-to-peer operation of the present invention. First and second wireless handsets 100₁, 100₂ are capable of communicating with each other via the public wireless network 110 (which, of course, comprises both wired and wireless components). In a typical session, the user of handset 100₁ operates the handset to send a location query to handset 100₂ via network 110 using SMS, IM, or other suitable messaging protocol facilitating direct peer-to-peer communication. When handset 100₂ receives the query, it determines, first, whether handset 100₁ is a trusted source of queries. If so, handset 100₂ determines its own location using on-board circuitry and/or use of the wireless carrier's position-determination equipment (PDE). Additional geographic information can, if desired, be obtained through communication with a GIS 115. Handset 100₂ communicates with GIS 115 over the Internet, which it accesses via wireless network 110. When handset 100₂ determines its location, it prepares a response reporting the determined location, and communicates this response to handset 100₁ over wireless network 110. The location may be reported in terms of raw geographic coordinates, in the form of a map or street address, as a named place, etc. In most implementations, handsets 100₁, 100₂ will each be configured both to transmit and receive location queries. This is not essential, however; some handsets may, if desired, be configured solely to transmit tracking queries, while others may be configured to respond to, but not to transmit, location queries.

Any of numerous location-determining technologies (LDTs) can be used for tracking purposes; the present invention is LDT-agnostic, i.e., capable of operating based on virtually any LDT infrastructure. The “Cell ID” (cell site identification) approach, for example, derives the location of a wireless handset based on the nearest wireless base station. The accuracy of this approach, of course, depends on the cell size of the wireless network (typically 2-20 km), and can vary depending on numerous factors. The E-TOD (enhanced observed time difference) and OTDOA (observed time difference of arrival) approaches triangulate time shifts from at least three base stations. While better than a location estimate based on proximity to a single cell site, these approaches nonetheless degrade in urban areas (due to multipath reflections) as well as in rural areas (due to lack of coverage). The A-GPS (assisted global positioning system) approach uses signals generated by GPS satellites along with a cell network location server to process data, reduce start times, and improve indoor performance. Finally, hybrid approaches (e.g., A-GPS used in conjunction with Cell ID or E-OTD) offer improved accuracy over the individual techniques that are combined. Any of these approaches or others, alone or in combination, can be utilized to advantage.

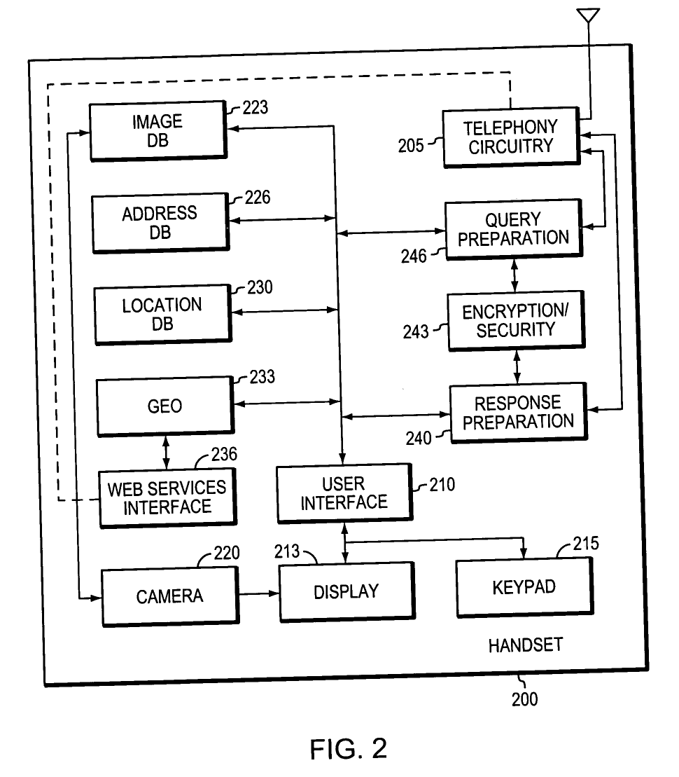

FIG. 2 conceptually illustrates the organization and components of a handset 200 in accordance with the invention. The illustrated handset includes both tracking and location-reporting components, it being understood, as explained above, that handsets in accordance with the invention need not include both types of capability (in which case corresponding components are omitted or disabled). Moreover, the querying devices may not be handsets at all, but may instead be PCs, laptops, handheld devices, etc. running an application that implements the functions described herein (e.g., as a local application running under an Internet browser in the manner of a plug-in). For convenience of presentation, however, the discussion will continue to focus on handsets, it is being understood that other suitable devices are contemplated as well.

Handset 200 contains conventional telephony circuitry 205, which transmits and receives voice and data via the public wireless network. A user interface 210 displays information on the handset's screen display 213, and receives user commends via the handset's keypad 215. Handset 200 desirably includes a conventional digital camera 220, which allows the user to record images of scenes or people. Images of individuals who will be tracked using the invention are stored in an image database 223 (which is ordinarily implemented in non-volatile storage, such as Flash memory or the like, using conventional database management programming). Image database 223 relates images to contact information for handsets associated with the pictured individuals, thereby permitting handset 200 to communicate with, and obtain the locations of, those handsets. An address database 226, which may share the same non-volatile storage block as image database 223, maintains a list of handsets, data enabling contact therewith (e.g., phone numbers), and associated privileges. For example, a portion of database 226 may provide a “buddy” database of trusted handsets having permission to query the location of handset 200. A location database 230 stores the coordinates of named locations and perimeters associated therewith, such that if the location of handset 200 is determined to fall within one of the defined perimeters, its presence at the associated named location can be presumed; this perimeter-based approach to location is sometimes referred to as “geofencing.” The user populates databases 223, 226, 230 by means of user interface 210 and any defaults (e.g., perimeter defaults) included in the system; typically such defaults are subject to user modification and override.

A geolocation module 233 determines the instantaneous geographic location of handset 200, using, for example, A-GPS. The raw geographic information acquired by module 233 may be translated into, for example, a map or street address using an external GIS, which is accessed by means of a web services interface 236. In particular, interface 236 communicates using SOAP or other web protocol with a remote, Internet-based GIS via telephony circuitry 205 and the public wireless network. Alternatively, a map, street address, or other more detailed geographic information may be obtained from an on-board geographic-information database (not shown), stored, for example, in Flash memory, rather than from an outside GIS.

Incoming location queries are initially processed by a response-preparation module 240, which may decrypt the queries using an encryption and security module 243. Response-preparation module 240 searches buddy database 226 to determine whether the query originated with a trusted handset, and if so, module 240 requests a location from geolocation module 233. Depending on the handset's default settings and/or information contained in the query, the module 240 may prepare a response based on raw geographic coordinates, or may instead cause geolocation module 233 to obtain more detailed (and meaningful) information from a GIS or on-board geographic-information database. For example, module 240 may obtain a street address and/or map and transmit this as part of the response. Alternatively, the querying handset may perform this function, receiving raw latitude/longitude coordinates and querying an external GIS (or internal database) for a map. Module 240 may, if desired, gather further information, such as a telephone number, from Internet-accessible or on-board databases and include this information in the response. Finally, response preparation module 240 may first search location database 230 to determine if the raw geographic coordinates fall within a listed perimeter, in which case the response will report the corresponding named location.

Outgoing queries to a tracked handset are prepared by a query-preparation module 246, typically based on the user's interaction with user interface 210 (via keypad 215 and display 213). For example, the user may designate one of the images in image database 223, in which case the query will be sent to the corresponding handset. Alternatively, the user may simply enter the telephone number of the handset of interest. Query-preparation module 246 may interact with encryption/security module 243 to encrypt the query prior to sending it.

The present invention may also be configured for “push” or alert-based operation in which location messages are sent automatically rather than in response to explicit requests. In a push configuration, the handset 200 periodically determines its location and, simultaneously or less frequently, transmits a message indicating that location to an authorized station. In an alert-based configuration, the location message is sent in response to the occurrence of an event. In either case, the message is prepared by response-preparation module 240 and transmitted as described above, but functionality for processing queries is not relevant to these operations (and in some embodiments, configured only for push or alert-based operation, may be omitted entirely). To maintain security, the receiving or “monitoring” station will have authenticated itself to handset 200 before any location messages are sent thereto.

The invention may be responsive to various types of local and remote alerts:
1. When the handset 200 enters or leaves a predefined fixed area/location.
2. When the handset 200 enters or leaves a proximity area of the monitoring station.
3. When the handset 200 enters or leaves a proximity area of another designated phone.
4. When the handset 200 has not moved for a predefined period.
5. When the handset 200 starts moving again, after staying still for a predefined period.
6. When the handset 200 is turned on/off.
7. When the handset 200 receives a voice call from, or calls, a predefined number.

These alerts may either be built into the basic functionality of an application implementing the invention and/or may be configured on the target phone directly (by the user), as well as remotely (from another phone or from a PC). Moreover, it is not necessary for the handset 200 to detect its location in response to an alert (or even in response to a location query). Instead, to improve response time, handset 200 may be configured to determine its location periodically and cache the location in memory, fetching the most recently cached location in response to an alert or a location query.

In accordance with the present invention, stations may communicate in peer-to-peer mode, in which both stations have the same rights and privileges, can configure their own settings, and can access the other station's settings remotely only with an explicit consent of the other station's owner. Other operational modes are possible, however. In “master-slave” mode, the slave station has limited access to its own settings and no remote access to the master phone settings, while the master phone can remotely control and alter the slave phone settings without explicit consent from the slave phone owner. The controlled features may include:
1. Setting slave station password.
2. Access to the master station location.
3. Allowing another phone to monitor a slave phone.
4. Allowing a slave phone to monitor another phone.
5. Setting slave phone alerts.

A phone may enter “stand-alone” mode when connectivity is limited or non-existent. In this mode, the phone can still collect information from its geolocation module 233 and generate deferred alerts, which will be transmitted once the connectivity is restored. Deferred alerts are “persisted” such that even if the phone is turned off before connectivity is restored, alerts will still be transmitted when connectivity is again detected. Time stamps are desirably associated with alerts so that alert-receiving applications can detect a time differential between manifestation of the alert and the time it was actually sent.

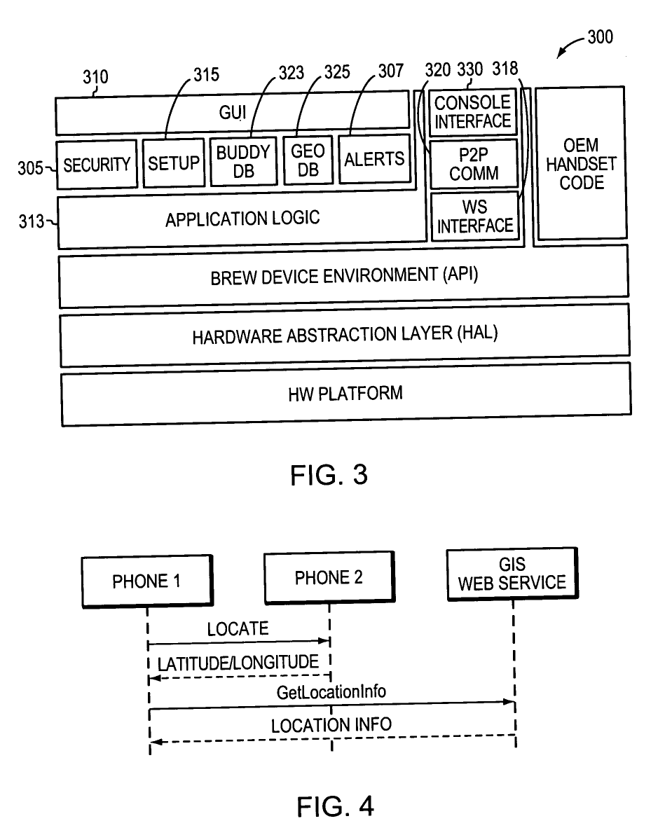

It should be understood that the illustrated components represent operative functionality but not necessarily discrete modules or elements. So long as the functions associated with the components are realized, their distribution among elements, or implementation in software and/or hardware, is not critical to the invention. FIG. 3 illustrates a code architecture 300 in which the functionality shown in FIG. 2 is implemented in software (SW) modules that fulfill standard Qualcomm Corporation guidelines (which specify available resources and permitted interfaces). One embodiment is implemented on cell phones built using a Qualcomm chipset running the Binary Runtime Environment for Windows (BREW) operating system. It should be emphasized, however, that these implementations are provided merely for illustrative purposes. The invention can be deployed on any platform using any operating system, and it is not necessary for querying and tracked stations to be running the same operating system in order to interoperate transparently.

The application 300, running on a mobile phone, may request the geographic location of another mobile phone with the same application running on it. The application 300 on the target phone then obtains its own location from a built-in GPS device and transmits its coordinates to the requesting phone, which displays the results on its screen. Results may be presented in the form of an address, or a map, where the target phone location is marked.

In addition to locating another phone, the application 300 can generate predefined configurable alerts, e.g., when a phone enters or exits a specific geographical area, stays for too long in a specific area, does not move for a long time, starts moving after remaining in place for too long, etc. Alerts can be requested by another application instance, but are fully controllable by the target phone and can be rejected if desired.

The security block 305 (corresponding to block 243 in FIG. 2) manages passwords, encryption/decryption of messages, and user authentication. The alerts block 307 is responsible for storing and enforcing notification parameters and delivery. The GUI block 310 (corresponding to block 210 in FIG. 2) presents information to the user and collects user input. The application logic block 313 executes the basic functions of the application 300. The setup block 315 facilitates specification and storage of system parameters. The web services (WS) interface block 318 (corresponding to block 236 in FIG. 2) provides an interface to the Web-based service resources such as a GIS. The P2P communication block 320 provides communication services for the peer-to-peer link. The buddy database 323 (corresponding to block block 226 in FIG. 2) stores information about the access permissions for contacts stored in the address book. The geographic database 325 stores geographical information relevant to the current application setup. The console interface 330 is responsible for communications external to the phone. It permits, for example, connection of the handset to a PC using cable, in which case the console interface 330 will be responsible for interacting with the PC.

Various functions performed by the invention will now be described in greater detail.

Location Request Processing

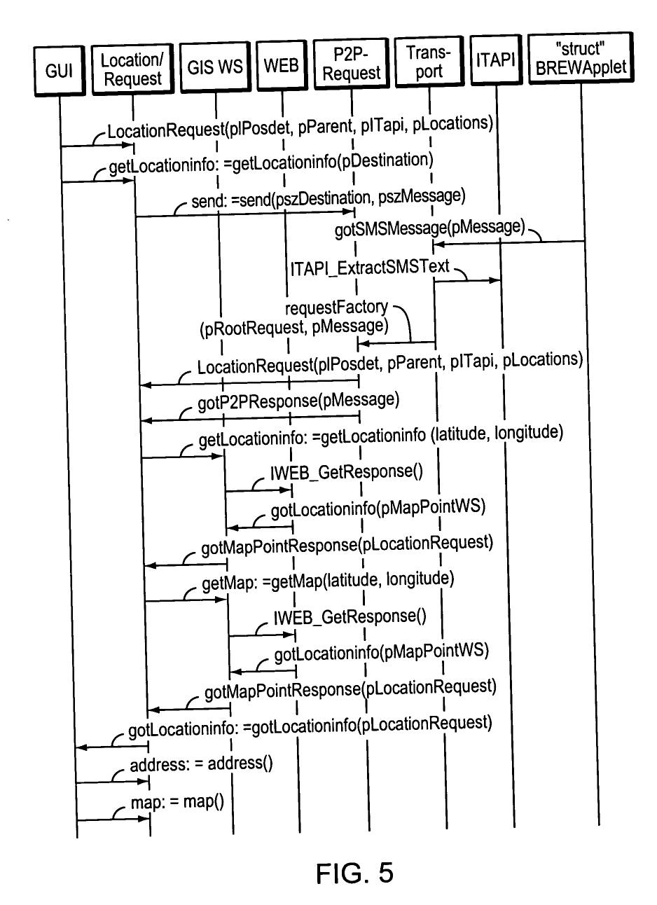

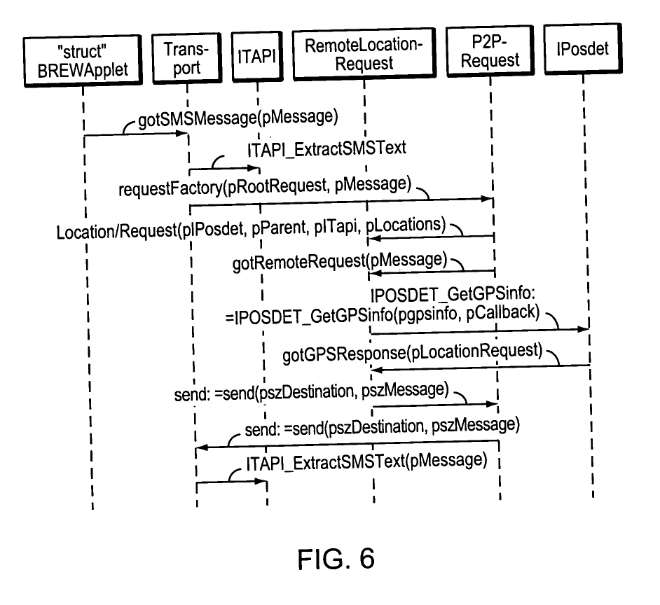

FIGS. 5 and 6 illustrate processing of location requests in an embodiment of the invention utilizing two application classes: LocationRequest and GIS WS. The LocationRequest class is responsible for both local and remote location request processing. This class is initiated every time a location request needs to be processed. Its constructor is passed Internet transport API (ITAPI) and IPosdet interface pointers, which are initiated when the application 300 starts. The class uses ITAPI to send SMS messages to other phones, and IPosdet to obtain the phone location information. It has the following static callback functions:
gotP2PResponse( ) is called when a SMS reply message with a location information is received from another phone.
gotGPSResponse( ) is registered with the IPosdet interface and is called when a GPS information becomes available.
gotMapPointResponse( ) is called when a GIS (e.g., MapPoint) response is available.
gotRemoteRequest( ) is called when an SMS location request message is received from another phone.

MapPointWS represents a request to Microsoft Corporation's MapPoint Web Service. This class is initiated as part of LocationRequest and has two methods and one static callback:
getLocationInfo( ) is called to obtain the location address from its coordinates.
getMap( ) is called to obtain a graphic map for a location.
gotMapPointResponse( ) is a callback registered with an IWeb interface and is called when a response arrives from MapPoint.

FIG. 5 illustrates the interaction between the above classes. As illustrated in the figure, a GUI routine instantiates the LocationRequest class, saving its pointer in the applet memory in a linked list. Besides pointers to BREW interfaces, such as IShell, ITAPI, etc., a new request ID is generated for the LocationRequest. The GUI routine then calls the LocationRequest::getLocation( ) method, passing it a pointer to a destination string containing the target phone number.

LocationRequest then sends a location request message via P2PRequest and SMS to the target phone. The application subscribes to BREW SMS CMT-95 messages in its MIF or during the initialization. When a response to this remote request arrives, the application event handler receives EVT_NOTIFY and calls the static Transport::gotSMSMessage( ) method, passing a pointer to AEESMSMessage. This function calls ITAPI_ExtractSMSText( ) and then P2PRequest::requestFactory( ). If this is a remote location request it calls LocationRequest::gotRemoteRequest( ). If this is a response to a previously sent location request, its request ID is used to find the request in the request linked list in the applet memory, and then call LocationRequest::gotP2PResponse( ).

LocationRequest::gotP2PResponse( ) extracts remote location information from the message, instantiates MapPointWS, and calls MapPointWS::getLocationInfo( ). MapPointWS::getLocationInfo( ) posts a GetLocationInfo SOAP request to the MS MapPoint Web Service, registering static MapPointWS::gotLocationInfo( ) as a callback. MapPointWS::gotLocationInfo( ) is called when a response arrives from MapPoint. Next, a GetMap SOAP request is sent and the result is processed in the same callback.

Remote location-request processing is illustrated in FIG. 6. The application 300 subscribes to BREW SMS CMT-95 messages in its MIF or during the initialization. When a new SMS message arrives, the application event handler receives EVT_NOTIFY and calls static TRansport::gotSMSMessage( ), which calls ITAPI_ExtractSMSText( ) and then P2PRequest::requestFactory( ). If this is a response to a previously sent location request, it is processed. If this is a remote location request, P2PRequest::requestFactory( ) instantiates the LocationRequest class and calls LocationRequest::gotRemoteRequest( ). LocationRequest then obtains the phone GPS information and sends it back via a SMS reply message.

Address database 226 (see FIG. 2) preferably maintains all phone numbers that will have an access to location information of the handset 200, as well as those that will be monitored by handset 200. In order to avoid duplication of information, a phone number is stored once, in a single record, along with access privileges associated therewith. Database 226 is a persistent database.

If a new phone number is defined, it is stored in (or, if already present, selected from) the address database entries. The owner of the handset 200 may enter or reconfigure the permissions associated with an entry (e.g., selected for monitoring but cannot itself monitor the handset 200, or can monitor the handset 200 but cannot itself be monitored).

User interface 210 may be configured to permit instant association between an image recorded by camera 220 and a selected record in address database 226. The user selects a record, takes a picture with camera 220, and selects the option ASSOCIATE PICTURE WITH SELECTED RECORD? query generated by user interface 210. The picture is stored in image database 223 and a pointer to the stored image is entered into the user-selected record in address database 226. Each image in database 223 may be presented by user interface 210 as a button, allowing the user to query the location of the associated phone with a single selection.

The “buddy” database contains one record for each station allowed to use the location-detection features of the owner's phone. Actual data about buddy (name, address, phone number, etc.) is contained in address database 223 like any other record, but the “buddy” field is set to identify an entry having buddy privileges.

Location database 230 holds information about the geographical objects and features that are used as a reference system. It can contain, for example, a residence location (expressed in terms of latitude/longitude coordinates), school location, shopping mall location, etc. Location descriptions are entered by the user via user interface 210, either manually or, more typically, by actually visiting the location, in which case the location is determined by geolocation module 233. A representative location record will include the latitude and logitude of each named location, as well as offset values that define a bounding rectangle around the object; locations within the rectangle are presumed to be co-located with the object. The boundaries of the rectangle may be default values or user-entered values. Default values may be labeled for different types of locations so that user need not deal with actual dimensions. For example, the value list may contain boundaries corresponding to residences, shopping malls, schools, gas stations, etc. When user selects from this list, the appropriate offset values are entered into the location record for the associated object.

In a representative GUI, the user is presented with list of locations already in the location database 230. The user can add a new location or re-record an existing location. The first entry in the list is NEW LOCATION, which is also the only entry if he location database 230 is empty.

If the user chooses NEW LOCATION he is presented with a window to enter the new location name. It can be any name up to 32 characters long, e.g., HOME, SCHOOL, MOVIE, GRANDMA, etc. In addition, the user chooses the location type out of a list of predefined types, which facilitates definition of a location bounding rectangle. Once the user confirms that the entries are accurate by pressing the “done” button, the phone measures its coordinates and stores them in location database 230 along with the name, type and bounding rectangle data.

If location database 230 contains previously recorded locations, the user can chose any of them for editing. The operation is identical to adding a new location. One possible source of error is the user's attempt to edit an existing location while being physically present in a different location, in which case, if the user is not careful, newly recorded coordinates will replace the correct coordinates.

Security

It is not possible to positively authenticate owner of the querying phone, but it is possible to associate a remote request with the phone number of the querying phone because the originating phone number is always present in SMS messages. The originating phone number may therefore be used to authenticate the user.

Access to the application settings is desirably protected by a password. A parent can set up all configuration parameters, such as alerts, on the child's phone and define her/his own password, thus preventing the child from altering them. All communications between phones, as well as between phones and the GIS, are preferably encrypted using internally generated keys. An initial key is generated when the application is first installed on a new phone.

In order for another phone to be able to obtain location information, the target phone must explicitly allow this by defining the requesting phone number in the local application settings. A querying phone sends its identity with a location request to the target phone. The target phone validates the requesting phone number and, if already defined, sends its location information back. Preferably, at no point are the location information and the target phone number present together in the same message.

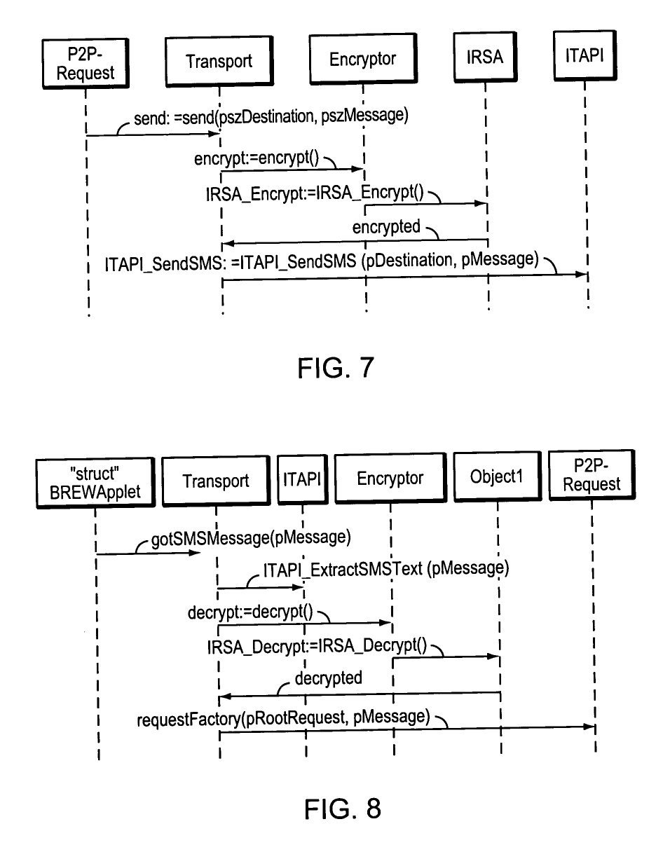

The sender encrypts every outgoing peer-to-peer message using an encryption key. The receiver decrypts an incoming message using the key. This schema, illustrated in FIGS. 7 and 8, requires the parties to know the key before exchanging information. As shown in FIG. 7, before sending a message, application 300 calls Encryptor::encrypt( ), providing a message and a destination. This function obtains an initial key from a key database and calls IRSA_Encrypt( ), which itself calls Transport::encrypted( ) callback when the encryption is complete.

Similarly, when a SMS message is received by the application (FIG. 8), application 300 calls Encryptor::decrypt( ), which schedules the Transport::decrypted( ) callback when decryption is complete.

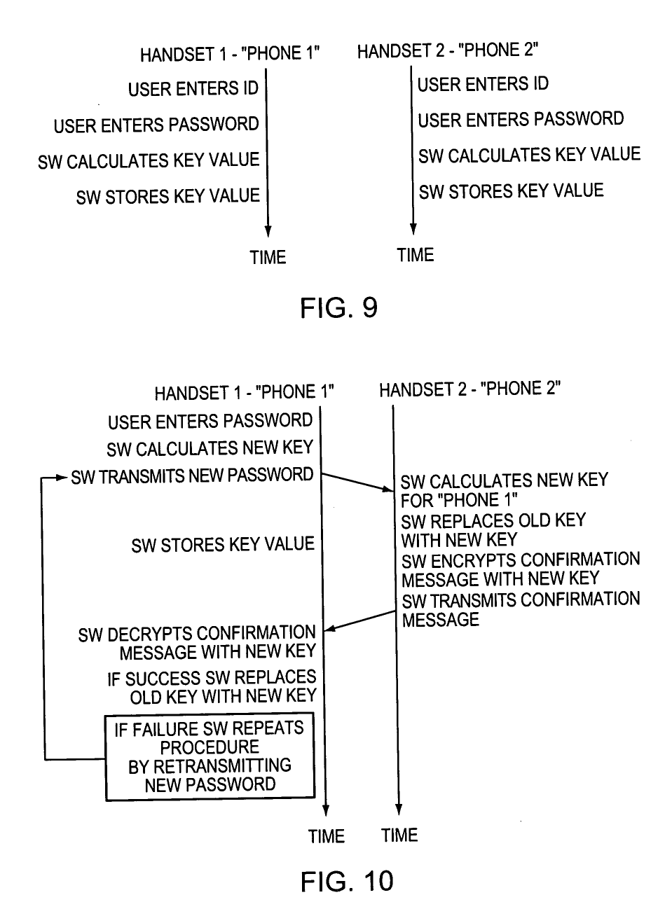

The present invention desirably includes means for automatically generating the encryption keys from user-selected proprietary information entered manually or programmatically into the handset. Suitable functionality is illustrated in FIGS. 9 and 10, in which a handset running an encryption application is designated as “phone1” and a handset running encryption application designated as “phone2.”

The actions involved in entering a user ID and password when setting the handset initially are shown in FIG. 9, and those involved in changing the setup of the already operational handset are illustrated in FIG. 10. When setting initially,
1. The user enters his user ID (UID) on the “phone1” handset.
2. The user enters his UID on the “phone2” handset.
3. The user enters his password on the “phone1” handset.
4. The user enters his password on the “phone2” handset.
5. On “phone1,” security module 243 calculates the key value using the UID and password on “phone1.” On “phone2,” security module 243 similarly calculates the key value using the UID and password on “phone2.” These key values are stored on the respective phones for use in SMS encryption.

When changing the setup of the already operational handset:
1. The user enters his new password on the “phone1” handset.
2. Security module 243 on “phone1” handset calculates new key for SMS encryption.
3. Security module 243 on “phone1” handset encrypts the new password with the old key.
4. The software application on the “phone1” handset transmits the encrypted new password to the “phone2” handset.
5. Security module 243 on the “phone2” handset deciphers the message with new key using the old key.
6. Security module 243 on the “phone2” handset replaces the old key for the “phone1” handset with the new key.
7. Security module 243 on the “phone2” handset encrypts confirmation message to the “phone1” handset with the new key.
8. Security module 243 on the “phone1” handset deciphers the confirmation message with the new key,

If deciphering of the confirmation message with the new key is successful, security module 243 on “phone1” replaces the old key with the new key. If deciphering of the confirmation message is not successful, security module 243 on “phone1” repeats the sequence shown in FIG. 10 starting with the steps shown above.

It will therefore be seen that the foregoing represents a highly versatile, self-contained and conveniently implemented approach to serverless implementation of wireless handset applications. The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed.

What is claimed is:

1. A method of performing location-based services involving first and second wireless stations in communication via a public wireless network, at least the second station being a handset including functionality for determining its location, the method comprising the steps of:
a. without use of an external resource, (i) preparing, on the first station, a peer-to-peer location request for the second station and (ii) causing transmission of the location request from the first station to the second station via the public wireless network;
b. receiving the peer-to-peer request at the second station;
c. causing the second station to determine its location; and
d. without use of an external resource, (i) preparing, on the second station, a peer-to-peer response including the determined location and (ii) causing transmission of the response from the second station to the first station via the public wireless network.

2. The method of claim 1 wherein the location-determining step includes wireless communication between the second station and an external server.

3. The method of claim 1 wherein the location-determining step is accomplished without use of an external resource.

4. The method of claim 1 further comprising the step of encrypting the request prior to transmission thereof.

5. The method of claim 4 wherein the encryption is accomplished on the first station without use of an external resource.

6. The method of claim 1 further comprising the step of encrypting the response prior to transmission thereof.

7. The method of claim 6 wherein the encryption is accomplished on the second station without use of an external resource.

8. The method of claim 1 wherein the request and response are transmitted using SMS.

9. The method of claim 1 wherein the request and response are transmitted using IM.

10. The method of claim 1 further comprising the step of displaying the location geographically on the first station.

11. The method of claim 1 further comprising the steps of characterizing the location using a name therefor, and displaying the name on the first station.

12. The method of claim 11 wherein the name is determined based on a determined geographic location and its proximity to a named location.

13. The method of claim 1 wherein the second station determines its location in response to the request.

14. The method of claim 1 wherein the second station determines its location periodically, the peer-to-peer response comprising a most recently determined location.

15. A method of performing location-based services involving first and second wireless stations in communication via a public wireless network, at least the second station being a handset including functionality for determining its location, the method comprising the steps of:
a. causing the second station periodically to determine its location; and
b. upon occurrence of an event and without use of an external resource, (i) preparing, on the second station, a peer-to-peer message based on the determined location and (ii) causing transmission of the message from the second station to the first station via the public wireless network.

16. The method of claim 15 further comprising the step of encrypting the message prior to transmission thereof.

17. The method of claim 16 wherein the encryption is accomplished on the second station without use of an external resource.

18. The method of claim 15 wherein the message is transmitted using SMS.

19. The method of claim 15 wherein the message is transmitted using IM.

20. The method of claim 15 wherein the event comprises receiving, at the second station, a location request from the first station.

21. The method of claim 15 wherein the event comprises entry of the second station into proximity to a predetermined location, the message comprising identification of the location.

22. The method of claim 15 wherein the event comprises elapse of a predetermined time.

23. A wireless telephone handset comprising:
a. telephony circuitry for receiving and transmitting voice and data via a public wireless network;
b. a user interface facilitating selection of a command to request, from a remote station, the location of the remote station;
c. a module, responsive to the command, for preparing, without use of an external resource, a location request for the remote station and for causing transmission of the location request by the telephony circuitry to the remote station via the public wireless network; and
d. a module for interpreting a response received by the telephony circuitry from the remote station, which response includes the determined location, and displaying the location on the user interface.

24. The handset of claim 23 further comprising, on the handset:
a. functionality for determining the location of the handset; and
b. a module, responsive to location requests transmitted by another handset, for preparing responses to the location requests, which responses include the determined location, and causing transmission, by the telephony circuitry, of the location requests to the other handset via the public wireless network.

25. The handset of claim 24 wherein the location-determining functionality effectuates communication between the handset and an external server in determining the location.

26. The handset of claim 24 wherein the location-determining functionality determines the location without use of an external resource.

27. The handset of claim 23 further comprising functionality for encrypting the request prior to transmission thereof.

28. The handset of claim 27 wherein the encryption is accomplished without use of an external resource.

29. The handset of claim 24 further comprising functionality for encrypting the responses prior to transmission thereof.

30. The handset of claim 29 wherein the encryption is accomplished on the handset without use of an external resource.

31. The handset of claim 24 wherein the request and the responses are transmitted using SMS.

32. The handset of claim 24 wherein the request and response are transmitted using IM.

33. The handset of claim 24 wherein a response characterizes the associated location geographically.

34. The handset of claim 24 wherein the response characterizes the location using a name therefor.

35. The handset of claim 24 wherein the name is determined based on a determined geographic location and its proximity to a named location.

36. The handset of claim 24 further comprising memory circuitry for storing digital images each associated with data facilitating communication with a remote station, the user interface facilitating display of and selection among the digital images, selection of an image causing preparation and transmission of the location request to the remote station associated with the image.

37. The handset of claim 36 further comprising a camera for recording the digital images, the user interface facilitating association between a recorded image and data facilitating communication with a remote station.

38. The handset of claim 24 wherein the handset determines its location in response to location requests transmitted by another handset.

39. The handset of claim 24 wherein the handset determines its location periodically, the prepared response comprising a most recently determined location.

40. A wireless telephone handset comprising:
a. telephony circuitry for receiving and transmitting voice and data via a public wireless network;
b. functionality for periodically determining the location of the handset; and
c. a module for preparing messages based on the determined location and, in response to occurrence of an event, causing transmission, by the telephony circuitry, of the message to another handset via the public wireless network.

41. The handset of claim 40 further comprising functionality for encrypting the message prior to transmission thereof.

42. The handset of claim 41 wherein the encryption is accomplished on the handset without use of an external resource.

43. The handset of claim 40 wherein the message is transmitted using SMS.

44. The handset of claim 40 wherein the message is transmitted using IM.

45. The handset of claim 40 wherein the event comprises a location request received from a remote station.

46. The handset of claim 40 wherein the event comprises entry of the handset into proximity to a predetermined location, the message comprising identification of the location.

47. The handset of claim 40 wherein the event comprises elapse of a predetermined time.

48. A computer-readable storage medium containing a set of instructions for a general-purpose computer, the set of instructions comprising:
a. instructions defining a user interface facilitating selection of a command to request, from a remote station, the location of the remote station;
b. a routine, responsive to the command, for preparing, without use of an external resource, a location request for the remote station and for causing transmission of the location request to the remote station via the public wireless network; and
c. a routine for interpreting a response received from the remote station, which response includes the determined location, and displaying the location on the user interface.

49. A computer-readable storage medium containing a set of instructions for a general-purpose computer, the set of instructions comprising:
a. a routine for periodically determining the location of a handset; and a routine for preparing messages based on the determined location and, in response to occurrence of an event, causing transmission of the message to another handset via the public wireless network.
